(19) United States
(12) Patent Application Publication
(10) Pub. No.: US 2025/0323237 A1
(43) Pub. Date: Oct. 16, 2025

(54) MULTI-SCALE FABRICATION TO ENABLE HIGH ENERGY DENSITY THICK ELECTRODES

(71) Applicants: Jonghyun Park, Rolla, MO (US); Gracie Boyer, Rolla, MO (US); Jacob Sutton, Rolla, MO (US)

(72) Inventors: Jonghyun Park, Rolla, MO (US); Gracie Boyer, Rolla, MO (US); Jacob Sutton, Rolla, MO (US)

(73) Assignee: The Curators of the University of Missouri, Columbia, MO (US)

(21) Appl. No.: 19/178,245

(22) Filed: Apr. 14, 2025

Related U.S. Application Data
(60) Provisional application No. 63/633,508, filed on Apr. 12, 2024.

(51) Int. Cl. H01M 4/04; H01M 4/02

(52) U.S. Cl. CPC H01M 4/0409; H01M 2004/021

(57) ABSTRACT

High-density thick electrodes are provided for forming a battery. The electrodes may be formed by laser structuring a pattern on a current collector surface, casting an electrode material slurry on the current collector surface to form a wet intermediate electrode, drying the wet intermediated electrode to form the electrode, shaping the electrode, and laser structuring the electrode to include an interdigitated pattern and one or more ion transport routes. An electric field may be applied during casting and drying to aid in particle alignment.

### CROSS-REFERENCE TO RELATED APPLICATION

This application claims priority to U.S. Provisional Patent Application No. 63/633,508, filed Apr. 12, 2024, the entire disclosure of which is incorporated herein by reference.

### FIELD

Provided herein are methods for preparing electrodes. The methods comprise, in certain configurations, the presence of an electrical field during preparation of the electrode and/or laser structuring of the electrodes. Also provided herein are batteries comprising the electrodes.

### BACKGROUND

While lithium-ion batteries continue to dominate as the preferred power source for various electronics, two significant concerns loom over their future. First, the traditional planar cell design is nearing its volumetric energy density limit, prompting the need for alterations in internal cell chemistry or architecture to drive further improvements. Second, the era of liquid electrolytes is on the decline, with more companies shifting their focus towards batteries featuring safe, solid-state electrolytes capable of integration into flexible or load-bearing systems.

Therefore, there has been recent focus on improved battery designs. Particularly, the formation of dense or thick electrodes. However, current methods for forming the active material into dense, single layer, thick electrodes have encountered a number of issues related to mechanical stability and cyclability of the electrodes. For example, delamination of the electrode material from the current collector during drying, the requirement of a high viscosity slurry typically results in uneven electrode surfaces post-drying, tortuous pathways that restriction diffusion, long transport distances between the electrodes, etc.

Therefore, a need exists for new and improved methods and systems for forming thick electrodes and batteries that overcome the issues previously encountered.

One aspect of the present disclosure relates to the use of laser etching to overcome or mitigate delamination of the electrode from the current collector. For example, laser etching to control the roughness, increase the surface area, and promote adhesion to the current collector.

Other aspects of the present disclosure relate to processing the electrode to ensure an even electrode surface and overcome problems inherent in non-uniform electrodes (e.g., lithium-ion concentration gradients, increased internal resistance, lithium plating, etc.).

Still further aspects of the present disclosure relate to the use of laser structuring processes for reducing the travel distance and difficulty between the electrodes, thereby improving performance and ion transport.

### SUMMARY

One aspect of the present disclosure is directed to a method for preparing an electrode. The method comprises providing a current collector with a structured pattern on at least one surface thereof and an electrode material slurry. The electrode material slurry is cast onto the at least one surface of the current collector having a structured pattern to form a wet intermediate electrode. The wet intermediate electrode is dried to form the electrode.

Certain aspects of the present disclosure are directed to applying an electrical field during casting and drying.

Further aspects are directed to methods for preparing an electrode comprising casting an electrode material slurry on at least one surface of a current collector having a structured pattern to form a wet intermediate electrode. The wet intermediate electrode is dried to form the electrode and the electrode is then laser structured.

An additional aspect of the present disclosure is directed to a battery comprising an anode and a cathode. The anode comprises an interdigitated pattern on at least one surface thereof. The anode comprises one or more ion transport routes through the anode, and the thickness of the anode, as measured at any two points on a corresponding surface of the anode, differs by about 0.5 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less. The cathode comprises an interdigitated pattern on at least one surface thereof. The cathode comprises one or more ion transport routes through the cathode, and the thickness of the cathode, as measured at any two points on a corresponding surface of the cathode, differs by about by about 0.5 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less. The interdigitated pattern on at least one surface of the anode is configured to align to the interdigitated pattern on at least one surface of the cathode.

Other objects and features will be in part apparent and in part pointed out hereinafter.

### BRIEF DESCRIPTION OF THE DRAWINGS

FIG. 1 is an illustration of a cross-section of a conventional multi-layer microbattery.

FIG. 2 is an illustration of a cross-section of a conventional single-layer-thick microbattery.

FIG. 3 is an illustration of a cross-section of a single-layer-thick high energy density battery.

FIG. 4 is an exploded perspective of the single-layer-thick high energy density battery of FIG. 3.

FIG. 5 is a schematic diagram illustrating a system for manufacturing a high-energy-density-thick-electrode.

FIG. 6 is a flow chart illustrating an exemplary method for preparing an electrode.

FIG. 7 is a flow chart illustrating an exemplary method for forming a battery.

FIG. 8A illustrates a pillared casing method for creating interdigitated electrode structures.

FIG. 8B illustrates an embodiment of FIG. 8A comprising an electric field to aid in particle arrangement.

FIG. 9A is an exemplary design of a conventional thick electrode cell.

FIG. 9B is an exemplary design of a thick electrode cell of one embodiment of the present disclosure.

FIG. 9C is a prepared electrode of one embodiment of the present disclosure comprising ion diffusion routes (i.e. holes) and an interdigitated pattern.

FIG. 9D shows the interlocking of two electrodes having complimentary interdigitated patterns.

FIG. 10A shows the specific charging capacity of the design of FIG. 9B.

FIG. 10B shows the specific discharge capacity of the design of FIG. 9B.

FIG. 11A is an exemplary design of a conventional anode-less thick electrode cell.

FIG. 11B is an exemplary design of an anode-less thick electrode cell of one embodiment of the present disclosure.

FIG. 11C is a prepared electrode of one embodiment of the present disclosure comprising ion diffusion routes (i.e. holes) and groove patterns.

FIG. 11D shows a profile view of the electrode of FIG. 11C detailing the grooves present within the electrode.

FIG. 12A shows the specific charging capacity of a planar, liquid electrolyte, anode-less battery of Example 3.

FIG. 12B shows the specific discharge capacity of a planar, liquid electrolyte, anode-less battery of Example 3.

FIG. 13A shows the 3D printed casing for use in a pillared casing method of forming an interdigitated electrode.

FIG. 13B shows a battery assembly comprising the pillared casing of FIG. 13A.

FIG. 13C shows testing of the resulting battery structure of FIG. 13B.

FIG. 14A is an image of a cross-section of a laser-structured anode illustrating groove height of the anode.

FIG. 14B is an image of a cross-section of a laser-structured cathode illustrating groove height of the cathode.

FIG. 15A is an image of a cross-section of a laser-structured anode illustrating pillar and groove width of the anode.

FIG. 15B is an image of a cross-section of a laser-structured cathode illustrating pillar and groove width of the anode.

FIG. 16 is an image of an interdigitated anode and cathode.

FIG. 17 is an image of a laser-drilled hole through a cathode.

FIG. 18A is a cross-sectional image of a laser-structured anode.

FIG. 18B is a cross-sectional image of a laser-structured cathode.

FIG. 19A is a graph illustrating voltage during the first discharge cycle for a laser-structured battery that was prepared by applying an electric field during casting.

FIG. 19B is a graph illustrating the specific discharge capacity of a laser-structured battery that was prepared by applying an electric field casting.

FIG. 19C is a graph illustrating areal discharge capacity of a laser-structured battery that was prepared by applying an electric field during casting.

Corresponding reference characters indicate corresponding parts throughout the drawings.

### DETAILED DESCRIPTION

Lithium-ion batteries are the preferred power source for various electronics. However, these batteries present a number of challenges in the industry. The traditional planar cell design is nearing its volumetric energy density limit. Therefore, it is becoming necessary to investigate modifications to the internal cell chemistry or architecture of such batteries. Further, batteries are more frequently employing solid-state electrolytes in favor of traditional liquid electrolytes. The use of solid-state electrolytes allows for further modification and designs related to the manner in which they are integrated into the battery as well as the solid-state material potentially imparting strength to the battery (e.g., contributing to a load-bearing system).

A conventional lithium-ion microbattery follows the same fundamental structure as a large-scale lithium-ion battery, but is miniaturized for integration into compact devices such as micro-electro-mechanical systems (MEMS), biomedical implants, and microelectronics. Due to the nature of their use, lithium-ion microbattery structures generally have limited dimensions. For example, the typical thickness of such microbattery structures is <100 μm or employs a thin-film format, such that the amount of active material that can be present in the battery is limited. To increase capacity, microbatteries are generally formed to include either (i) multiple layers or (ii) a thick single layer. Multiple layer microbatteries necessitate additional current collectors and separators due to repeated stacking. Thick-single-layer microbatteries often have suboptimal performance. Previous manufacturing processes for thick-single-layer microbatteries introduced a number of issues that influenced the mechanical stability and cyclability of the microbatteries.

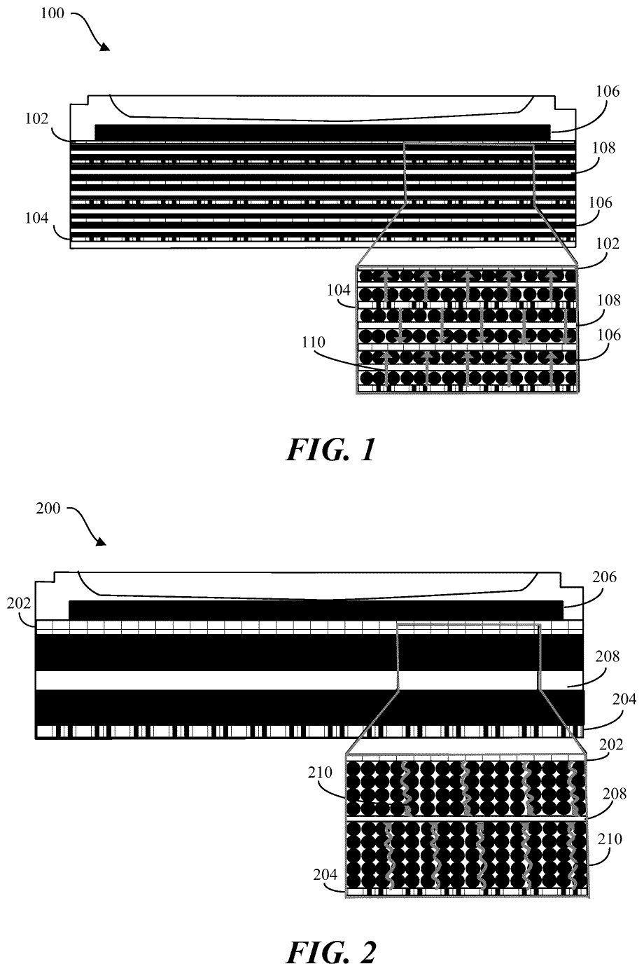

An example of a conventional multi-layer microbattery is shown at reference number 100 in FIG. 1. The multi-layer microbattery includes a significant number amount of current collectors and separators as a result of the stacking of multiple layers. For example, the multi-layer microbattery 100 includes copper current collectors 102, aluminum current collectors 104, electrode active material 106, separators 108, and ion pathways 110.

FIG. 2 shows an example of a conventional single-layer thick-electrode microbattery 200. The single-layer thick electrode microbattery 200 includes a copper current collector 202, an aluminum current collector 204, electrode active material 206, a separator 208, and tortuous ion pathways 210. Although the thick-electrode microbattery 200 eliminates the need for the high amount of current collectors and separators required by the multi-layer microbattery 100, the inventors have identified several manufacturability and performance issues with such thick-electrode microbatteries (i.e. that adversely affect the mechanical stability and cyclability of the single-layer thick-electrode microbattery 200). The electrode material often becomes delaminated from the current collector during drying. Further, a high viscosity slurry of electrode material is typically required to achieve the desired electrode thickness. This typically forms at least one uneven electrode surface post-drying, which results in non-uniform electrode contact areas.

Various embodiments of the present disclosure overcome these issues and allow for an improved battery cell and overall performance and longevity.

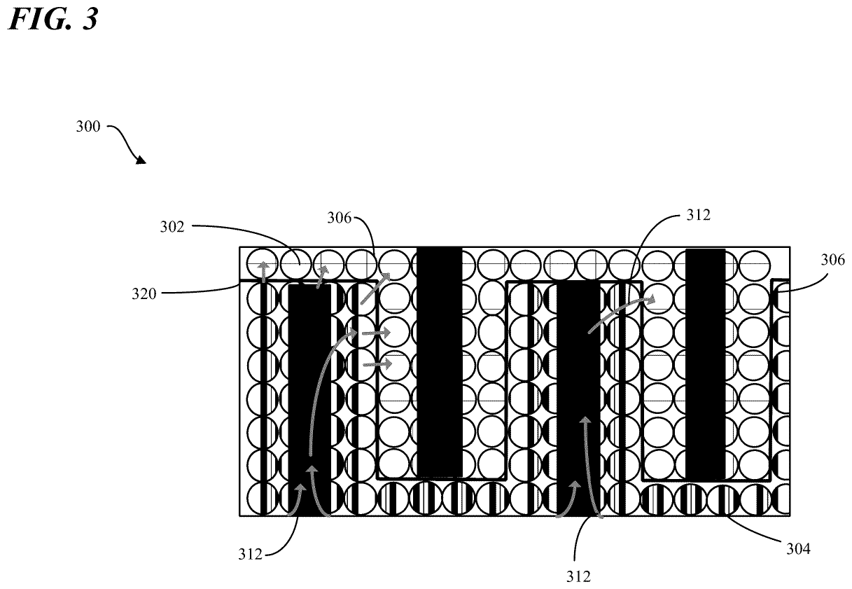

Referring now to FIG. 3, an exemplary battery in accordance with one embodiment of the present disclosure is indicated at reference number 300. The battery 300 comprises an anode 302 and a cathode 304 electrode, as well as a separator material 320. Individual features of the electrodes 302, 304 will now be described before turning to an exemplary method of preparing the electrodes and forming the battery 300.

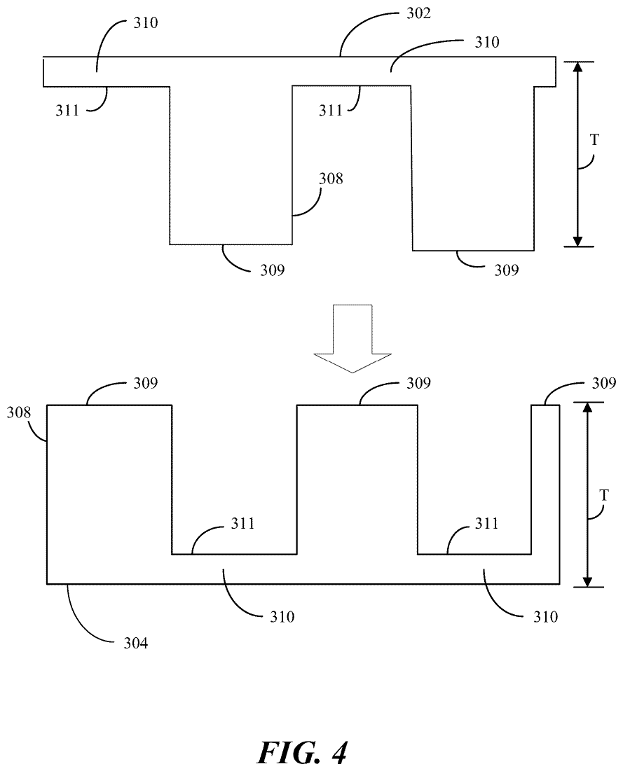

The anode 302 and cathode 304 each include interdigitated patterns 306 on at least one surface thereof. The interdigitated patterns 306 are configured to increase the surface areas of the anode 302 and cathode 304. Moreover, the interdigitated patterns 306 enable horizontal and vertical ion transport between the anode 302 and cathode 304. As shown in FIG. 4, the interdigitated patterns comprise pillars 308 and grooves 310 formed into the surfaces of the electrodes 302, 304. However, a person of ordinary skill in the art will understand that other structures may be used to form the interdigitated patterns 306, without departing from the scope of the present disclosure. The pillars 308 of the anode 302 are shaped and arranged to align with the grooves 310 of the cathode 304. Moreover, the pillars 308 of the cathode are shaped and arranged to align with the grooves 310 of the anode 302.

As described in further detail herein, it may be one aspect of the present disclosure that the electrode material is substantially uniform such that the risk of delamination of the electrode from the current collector is mitigated. In one embodiment, the thickness (T) of each electrode, as measured at any two points on a corresponding surface (e.g., a pillar surface 309 or groove surface 311) of the electrode, differs by about 0.5 mm or less, about 0.4 mm or less, about 0.3 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less. In another embodiment, the thickness T of each electrode, as measured at any two points on a corresponding surface of the electrode, differs by from about 2 μm to about 0.5 mm, from about 2 μm to about 0.4 mm, from about 2 μm to about 0.3 mm, from about 2 μm to about 0.2 mm, from about 2 μm to about 0.1 mm, from about 2 μm to about 75 μm, from about 5 μm to about 75 μm, from about 10 μm to about 75 μm, from about 12 μm to about 75 μm, from about 20 μm to about 75 μm, from about 25 μm to about 75 μm, from about 25 μm to about 70 μm, from about 25 μm to about 65 μm, from about 25 μm to about 60 μm, from about 25 μm to about 55 μm, from about 25 μm to about 50 μm, from about 30 μm to about 50 μm, or from about 35 μm to about 45 μm. For example, in one embodiment, the thickness T of each electrode, as measured at any two points on a corresponding surface of the electrode, differs by about 40 μm or less. In another embodiment, each corresponding surface of each electrode 302, 304 comprises a uniform thickness T. In further embodiments, the thickness T of each electrode, as measured at any two points on a similar interdigitated structure (e.g., two points on a pillar surface 309 or two points on a groove surface 311) differs by about 0.5 mm or less, about 0.4 mm or less, about 0.3 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less. In another embodiment, the thickness T of each electrode, as measured at any two points on a corresponding surface of the electrode, differs by from about 2 μm to about 0.5 mm, from about 2 μm to about 0.4 mm, from about 2 μm to about 0.3 mm, from about 2 μm to about 0.2 mm, from about 2 μm to about 0.1 mm, from about 2 μm to about 75 μm, from about 5 μm to about 75 μm, from about 10 μm to about 75 μm, from about 12 μm to about 75 μm, from about 20 μm to about 75 μm, from about 25 μm to about 75 μm, from about 25 μm to about 70 μm, from about 25 μm to about 65 μm, from about 25 μm to about 60 μm, from about 25 μm to about 55 μm, from about 25 μm to about 50 μm, from about 30 μm to about 50 μm, or from about 35 μm to about 45 μm. For example, in one embodiment, the thickness T of each electrode, as measured at any two points on a similar interdigitated structure differs by about 40 μm or less. In one embodiment, the thickness T of each electrode, as measured at any two points on a similar interdigitated structure comprises a uniform thickness T.

The battery 300 comprises one or more ion transport routes 312 through each of the anode 302 and cathode 304. The ion transport routes 312 are configured to reduce anode-cathode travel distance and promote ionic diffusion. Certain embodiments of the present disclosure (as discussed in further detail herein) are directed to ion transport routes 312 that comprise one or more holes and/or one or more grooves through the electrodes. However, a person of ordinary skill in the art will understand that other structures may form the ion transport routes 312 without departing from the scope of the present disclosure.

The exemplified battery, and other batteries of the present disclosure, provide a number of benefits and improvements. For example, the battery is configured to reduce tortuosity of the pathways for the electrode particles. This may be accomplished by the micro-level control of the structure of the battery and the electric field thereof. Additionally, the interdigitation design decreases anode-cathode distance and increases volumetric energy density. Still further, the design allows for fast ion transport routes through the electrode bulk.

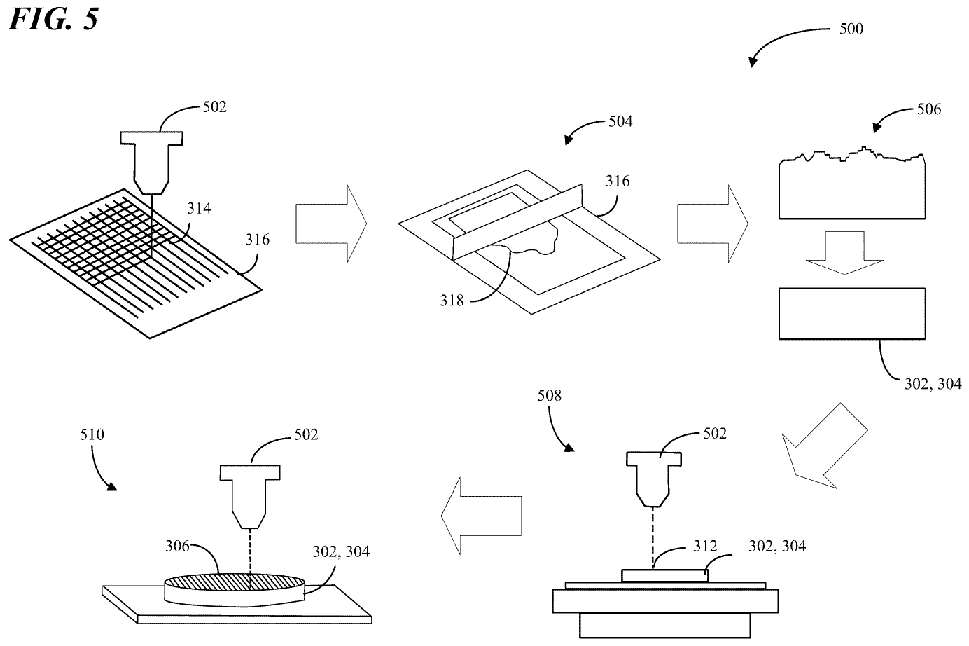

Referring now to FIG. 5, a system 500 for preparing an electrode is shown. Where reference herein is made to an “electrode” it will be understood that the discussion is equally applicable to the anode and/or cathode, unless otherwise indicated. The electrode preparing system 500 includes an ultrafast laser 502, a casting/drying station 504, and an electrode processing station 506.

In a first step, the ultrafast laser 502 (e.g., a femtosecond laser) is configured for laser structuring of a pattern 314 onto one or more surface of a current collector 316. In the illustrated embodiment, the structured pattern 314 comprises a grid pattern. However, it will be understood that other patterns or designs may be used without departing from the scope of the present disclosure.

The casting/drying station 504 is configured for casting of an electrode material slurry 318 onto the current collector surface 316, followed by drying to form an electrode. In certain embodiments, the electrode material slurry 318 is applied to one or more surface of the current collector 316 that has the structured pattern 314. In this way, the slurry 318 may have high surface area contact with the current collector surface 316. In certain embodiments, this high surface area contact allows for a stronger adhesion of the electrode material to the current collector surface and resulting electrode that has better mechanical properties. The casting and drying station 504 may also be configured, in certain embodiment, to facilitate the application of an electric field during the casting and/or drying processes (not shown). For example, in one embodiment, the casting and drying station 504 comprises a Kapton tape coated casting knife connected to a voltage source for applying an electric field during casting. In another embodiment, the casting and drying station 504 may comprise one or more metal plates connected to a voltage source and suitable for applying an electric field during drying.

In certain embodiments, the electrode material slurry is cast to a height of about 0.5 mm or greater, about 0.75 mm or greater, about 1.0 mm or greater, about 1.25 mm or greater, about 1.5 mm or greater, about 1.75 mm or greater, about 2.0 mm or greater, about 3.0 mm or greater, about 4.0 mm or greater, about 5.0 mm or greater, or about 10.0 mm or greater. In one embodiment, the electrode material slurry is cast at a height of from about 1.25 mm to about 1.75 mm.

In various embodiments, the voltage applied to the electrical field during casting is about 1 kV or greater, about 2 kV or greater, about 3 kV or greater, about 4 kV or greater, about 5 kV or greater, about 6 kV or greater, about 7 kV or greater, about 8 kV or greater, about 9 kV or greater, about 10 kV or greater, about 15 kV or greater, about 20 kV or greater, about 25 kV or greater, about 50 kV or greater, or about 100 kV or greater. In one embodiment, the voltage applied to the electrical field during casting is from about 5 kV to about 10 kV.

In certain embodiments, drying comprises drying at a temperature of about 30° C. or greater, about 35° C. or greater, about 40° C. or greater, about 45° C. or greater, about 50° C. or greater, about 55° C. or greater, about 60° C. or greater, about 65° C. or greater, about 70° C. or greater, about 75° C. or greater, about 80° C. or greater, about 85° C. or greater, about 90° C. or greater, about 95° C. or greater, or about 100° C. or greater.

In various embodiments, drying may comprise multiple drying protocols. For example, the drying may comprise one or more of drying via a hot plate, drying via an oven, drying via an electrical field, etc. in any order. In one embodiment, drying comprises drying via a hot plate with the application of an electrical field, followed by drying in an oven.

In one embodiment, drying comprises drying at a temperature of about 45° C. for about 7 hours, followed by drying at 70° C. for about 17 hours.

In various embodiments, the voltage applied to the electrical field during drying is about 1 kV or greater, about 2 kV or greater, about 3 kV or greater, about 4 kV or greater, about 5 kV or greater, about 6 kV or greater, about 7 kV or greater, about 8 kV or greater, about 9 kV or greater, about 10 kV or greater, about 15 kV or greater, about 20 kV or greater, about 25 kV or greater, about 50 kV or greater, or about 100 kV or greater.

The electrode processing station 506 is configured for shaping the electrode 302,304. For example, sanding of at least one dimension of the electrode 302,304. In certain embodiments it is desirable to produce an electrode 302,304 that is substantially uniform in at least one dimension. For example, having a top surface that is smooth (e.g., an electrode that deviates by about 40 μm or less in the height of the electrode). Shaping of the electrode may comprise any suitable mechanism to ensure that the required uniformity of the electrode is achieved, and is described in further detail herein. In one embodiment, the electrode processing station 506 further comprises a holder or guide for ensuring that the electrode does not move during shaping and/or is shaped to a predetermined dimension.

Following shaping of the electrode, the shaped electrode is subjected to further processing as shown in steps 508 and 510. As illustrated, the ultrafast laser 502 is used to form ion transport routes 312 in the electrode (e.g., micro-holes). In various embodiments, the ion transport routes may comprise a plurality of holes, wherein the holes have an average diameter of about 0.5 mm or less, about 0.4 mm or less, about 0.3 mm or less, about 0.2 mm or less, about 0.10 mm or less, about 95 μm or less, about 90 μm or less, about 85 μm or less, about 80 μm or less, about 75 μm or less, about 50 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less.

As shown in step 510, the ultrafast laser 502 also forms an interdigitated structure 306 on at least one surface of the electrode 302,304.

In certain embodiments, the ultrafast laser 502 forms an interdigitated structure wherein the width of each interdigitated part (e.g., each pillar or groove) is about 1 mm or less, about 0.9 mm or less, about 0.8 mm or less, about 0.7 mm or less, about 0.6 mm or less, about 0.5 mm or less, about 0.4 mm or less, about 0.3 mm or less, about 0.2 mm or less, about 0.1 mm or less or about 0.05 or less. In other embodiments, the width of each interdigitated part is from about 0.1 mm to about 0.5 mm, from about 0.2 mm to about 0.5 mm, or from about 0.2 mm to about 0.4 mm. In one embodiment, the width of each pillar is from about 0.1 mm to about 0.5 mm, from about 0.2 mm to about 0.5 mm, from about 0.2 mm to about 0.4 mm, from about 0.25 mm to about 0.4 mm, or from about 0.25 mm to about 0.35 mm and the width of each groove is from about 0.1 mm to about 0.5 mm, from about 0.2 mm to about 0.5 mm, or from about 0.2 mm to about 0.4 mm.

In some embodiments, the interdigitated structure/pattern may be formed by several passes of the high speed laser. For example, to achieve a groove width of 0.35 mm, six or more passes achieving a width of 0.0625 mm may be used. In another example achieving a groove depth of 0.25-0.37 mm, twelve or more passes may be taken to achieve the desired depth. It will be understood that the process may be modified in any way that is necessary (i.e. a number of successive laser passes) when the materials would be negatively impacted by prolonged exposure to the laser.

The ultrafast laser used in steps 508,510 may be the same or different from the ultrafast laser used in to form patterns 314 in the current collector surface. The further processing of steps 508 and 510 may be performed sequentially in any order, or only one of the processing steps 508 or 510 may be conducted. For example, in certain embodiments the electrode 302,304 is only subjected to step 508 for the formation of micro-holes as ion transport routes 312. In other embodiments, the electrode 302,304 is only subjected to step 510 (i.e. skipping step 508), such that an interdigitated pattern 306 is formed in the electrode.

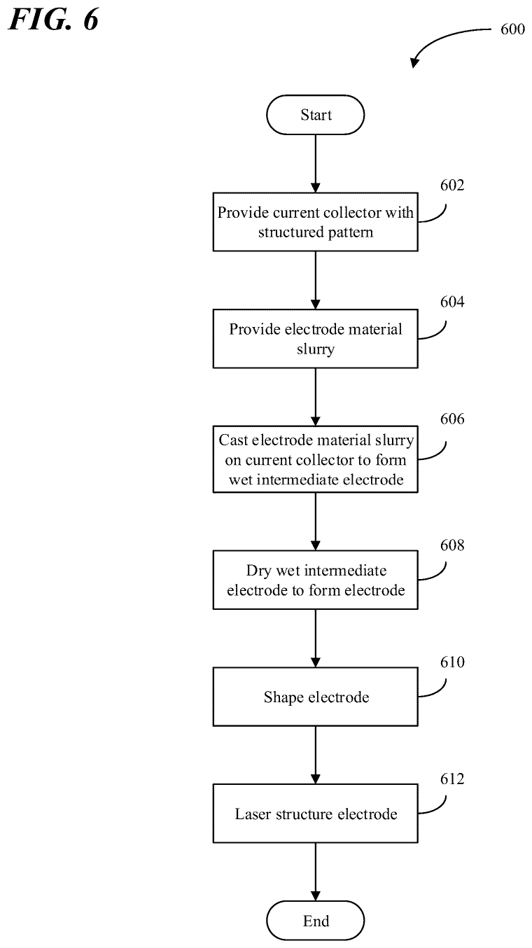

Referring now to FIG. 6, a method of preparing an electrode for forming an electrode is generally indicated at reference number 600. In certain embodiment, the method of 600 may be implemented for preparing the anode 302 and cathode 304 electrodes used in battery 300 discussed elsewhere herein.

The method begins at step 602 wherein a current collector is provided with a structured pattern on at least one surface thereof. As described elsewhere herein, in certain embodiments, this step may further comprise laser structuring a pattern onto at least one surface of the current collector. The structured pattern, for example, may be selected from the group consisting of a grid, grooves, holes, horizontal lines, and combinations thereof. In one embodiment, the structured pattern comprises a hole array. In certain embodiments, it may be necessary or desirable to secure the current collector (e.g., by tape or other adhesion to a metal surface) to ensure a precise structured pattern. A current collector having a structured pattern on at least one surface thereof has been discovered, in certain embodiments, to provide a controlled roughness on the current collector surface, an increased surface area, and increased adhesion of an electrode material slurry applied to the current collector surface having the structured pattern.

The current collector may comprise any material suitable for use as a current collector in the described method. In certain embodiments, the current collector comprises copper, aluminum, or combinations thereof. In some embodiments, the current collector is in the form of a foil. For example, the current collector may be selected from the group consisting of a copper foil, an aluminum foil, or combinations thereof. It will be understood that the current collector material may vary depending upon the intended use. For example, the current collector material may differ if the resulting electrode is intended to be a cathode vs. an anode. In one embodiment, a current collector for forming an anode comprises a copper foil current collector. In another embodiment, a current collector for forming a cathode comprises an aluminum foil current collector.

Next, at step 604, an electrode material slurry is provided. In certain embodiments, the electrode material slurry comprises a component selected from the group consisting of lithium manganese oxide (LMO), lithium nickel manganese cobalt oxide (NMC), lithium iron phosphate (LFP), mesocarbon microbeads (MCMB), polyvinylidene fluoride

(PVDF), carboxymethyl cellulose (CMC) binder, styrene butadiene rubber (SBR), carbon black, and combinations thereof. For example, in certain embodiments, the lithium nickel manganese cobalt oxide may comprise NMC811. It will be understood that the electrode material slurry will vary depending upon the intended use. For example, the electrode material slurry may differ if the electrode is intended to be a cathode vs. an anode.

In various embodiments, the electrode material slurry may comprise a solvent. In some embodiments, the solvent is selected from the group consisting of N-methylpyrrolidone (NMP), dimethylformamide (DMF), water, and combinations thereof.

In one embodiment, the electrode material slurry for an anode may comprise MCMB as the active material, carbon black as the conductive additive, PVDF as the binder, and N-methylpyrrolidone as the solvent.

In another embodiment, the electrode material slurry for the cathode may comprise NMC811 as the active material, carbon black as the conductive additive, PVDF as the binder, and N-methylpyrrolidone as the solvent.

The electrode material slurry is then cast on the surface of the current collector having the structured pattern to form a wet intermediate electrode in step 606. During casting, an electric field is optionally applied to aid in aligning particles of the electrode material slurry and/or to aid in controlling chemical reactions. In one embodiment, the electric field is applied using a casting knife that is connected to a voltage source (e.g., Kapton-tape-coated casting knife). However, it will be understood that any method for applying an electric field is encompassed without departing from the scope of the present disclosure.

At step 608, the wet intermediate electrode is dried to form the electrode. In certain embodiments, drying the wet intermediate electrode comprises drying the wet intermediate electrode on a hot plate. In other embodiments, drying the wet intermediate electrode may comprise drying in an oven. During drying, an electric field is optionally applied to aid in improving the quality of the final electrode. In one embodiment, the electric field is applied using a metal plate connected to a voltage supply, and supported above the electrode. However, it will be understood that any method for applying an electric field is encompassed without departing from the scope of the present disclosure. In various embodiments, drying the wet intermediate electrode may comprise multiple drying protocols. For example, the drying may comprise one or more of drying via a hot plate, drying via an oven, drying via an electrical field, etc. in any order. In one embodiment, drying comprises drying via a hot plate with the application of an electrical field, followed by drying in an oven.

In certain embodiments, during casting and/or drying, it may be necessary or desirable to fix the current collector to maintain a constant height and prevent warping during casting and drying steps.

After drying the wet intermediate electrode to form the electrode, at step 610, the electrode is shaped. As described elsewhere herein, previous batteries have suffered from uneven electrode surfaces post-drying. This can result in uneven distribution of the electrode material, non-uniform transport distances between the electrodes, non-uniform anode-cathode distances, etc. Further, such unevenness can result in lithium-ion concentration gradients across the battery cell surface, which increases the internal resistance, threatens the mechanical stability of the electrodes, and can cause lithium plating to occur at areas of high concentration. Therefore, certain aspects of the present disclosure are directed to shaping the electrode to ensure a sufficiently uniform surface.

It will be understood that the specific dimensions of the electrode will depend on the intended application (e.g., a uniform height of 900 μm for a microbattery). Therefore, certain embodiments are directed to shaping the electrode to ensure at least one substantially uniform dimension (i.e. deviation by no more than a set amount across a given dimension). For example, in one embodiment, a thickness of the electrode is processed such that, as measured at any two points on a corresponding surface of the electrode, the thickness differs by about 0.5 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less. In one example, processing the electrode thickness comprises sanding with sandpaper at least one surface of the electrode (e.g., as illustrated in step 506 of FIG. 5). Shaping the electrode in step 610 prior to further processing (e.g., Step 612) also helps to maintain a consistent working distance across the sample for further processing. In the case of laser structuring in step 612, a consistent or sufficiently uniform surface may be critical to achieve high resolution laser structures.

Finally, at step 612 the electrode is laser-structured to include at least one of (i) an interdigitated pattern into at least one surface of the electrode and (ii) one or more ion transport routes through the electrode.

In certain embodiments, the interdigitated pattern may be selected from the group consisting of pillars, grooves, and combinations thereof. For example, the interdigitated pattern may be selected from the group consisting of substantially uniform geometry pillars or grooves, tapered geometry pillars or grooves, and combinations thereof. Accordingly, the interdigitated pattern may enable horizontal and vertical ion transport routes between the anode and cathode electrodes. In general, the interdigitated pattern may be laser-structured into the electrode to increase the surface area of the electrodes. In certain embodiments, for example as shown in FIGS. 3 and 4, forming an interdigitated pattern allows for electrodes (i.e. an anode and cathode) to interlock with one another and provide a number of benefits regarding ion transport, travel distance to/from the anode and cathode, etc.

Laser-structuring of ion transport routes may include, but is not limited to, forming one or more holes, one or more grooves, and combinations thereof in the electrode. Similar to interdigitation patterns, laser-structuring of ion transport routes reduces the travel distance to/from the anode and cathode, improves the speed of ion transport, increases the electrode wettability, and improves the overall battery performance at high current rates.

In certain embodiments, step 612 comprises forming ion transport routes followed by forming an interdigitated pattern. In other embodiments, step 612 comprises forming an interdigitated pattern followed by forming ion transport routes.

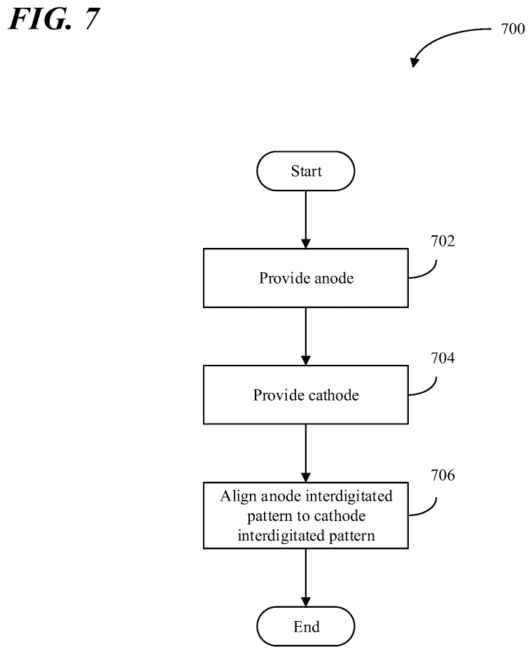

Referring now to FIG. 7, an exemplary method of forming a battery (e.g., a micro or large-scale battery) is provided at reference number 700. At steps 702 and 704, anodes and cathodes are provided. The anodes and cathodes may be provided, for example, by executing steps 602-612 of the method 600. The method 700 is particularly directed to electrodes that have been laser-structured to comprise interdigitated patterns. At step 706, the anode interdigitated pattern is aligned to the cathode interdigitated pattern to form the battery.

Although the formation of interdigitated patterns is described herein in the context of laser-structuring, any other method for forming the interdigitated patterns may be used. For example, in one embodiment, a pillared casing is used to create interdigitated electrode structures.

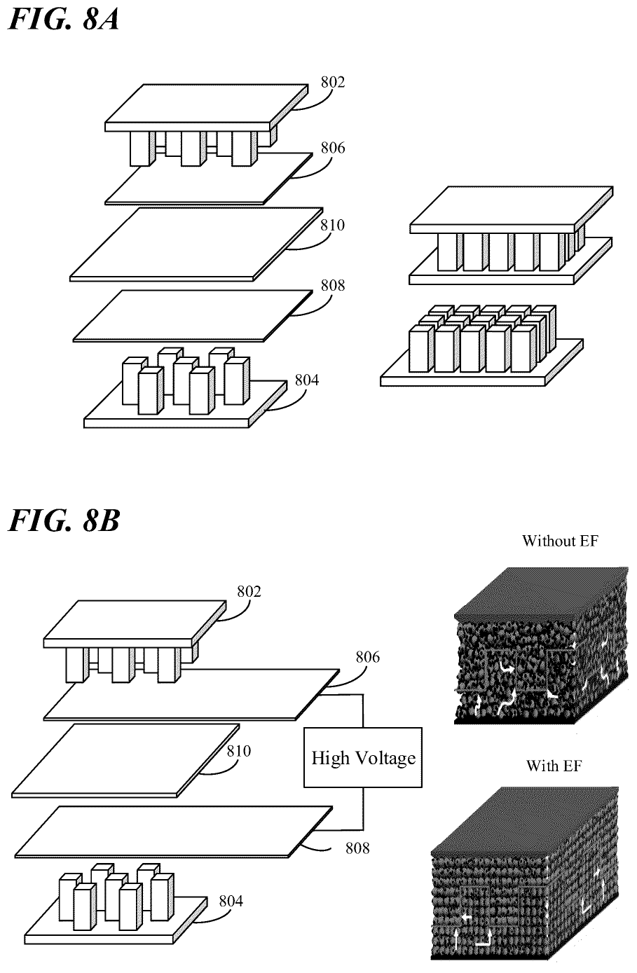

As shown in FIG. 8A a resin printed top casing 802 and resin printed bottom casing 804 is used to model the interdigitated pattern desired for each of the anode 806 and cathode 808. While a resin printed (e.g., 3D printed) structure as shown, the top and bottom casing 802, 804 may be formed by any suitable method. The anode 806, separator 810, and cathode 808 are pressed between the two casings, resulting in well-matched and interdigitated electrodes. Optionally, as shown in FIG. 8B, an electric field may be applied to aid in particle arrangement.

A benefit provided by pillared casing method is that the process can achieve a well-defined, repeatable structure, and may generally be conducted as a solvent-free process. Furthermore, this approach can be extended to polymer electrolytes without requiring any modifications.

While lithium-ion batteries continue to dominate as the preferred power source for various electronics, significant concerns loom over their future as discussed above. Namely, traditional planar cell design reaching its volumetric energy density limit, and changing focus towards batteries featuring safe, solid-state electrolytes capable of integration into flexible or load-bearing systems. To tackle these challenges, sophisticated equipment such as femtosecond lasers, renowned for their ability to intricately machine delicate materials due to their ultra-fast pulse length and minimal heat-affected zone, can be introduced into the electrode manufacturing process to craft innovative cell architectures. The present disclosure is directed, in certain embodiments, to harnessing an ultra-fast laser for micro-structuring electrode materials to unlock a myriad of advantages for lithium-ion batteries. These benefits encompass the development of micro-structuring designs that shorten ionic diffusion pathways and enhance electrolyte wettability, facilitating the utilization of thick electrodes. Additionally, the present disclosure allows for enhancement of the interfacial contact area between electrodes and solid polymer electrolytes (SPE), while also overcoming the challenge of low ionic conductivity in SPE/anode-less systems.

Advantageously, the present disclosure improves the volumetric energy density of microbatteries through the consolidation of active material in traditional stacked designs into a single layer anode-separator-cathode thick electrode design. This increase in energy density enables compact electronics, which are generally restricted by their power supply, to have greater run time and increased functionality. Additionally, the present disclosure overcomes disadvantages that are inherent to increasing the electrode thickness. For example, the present disclosure involves laser structuring current collector(s) to eliminate delamination of the electrode material from the current collector during drying. Accordingly, the present disclosure improves the thick electrode adhesion to the current collector through controlled laser-roughening of the current collector surface. Furthermore, the electrode surfaces are shaved down post-drying to eliminate uneven electrode surfaces. Moreover, by laser structuring the interdigitated pattern and ion transport routes into the electrodes, the present disclosure reduces tortuosity, increases surface area, enhances wettability, and decreases electrode-electrode ion transport distances thereby promoting ionic diffusion. Additionally, by coupling the laser-structured interdigitated pattern with the electric field casting and drying processes, electrodes are created that have a controlled structured on both micro and macro levels.

### EXAMPLES

### Example 1

In a first example, multi-scale structured thick electrodes were formed.

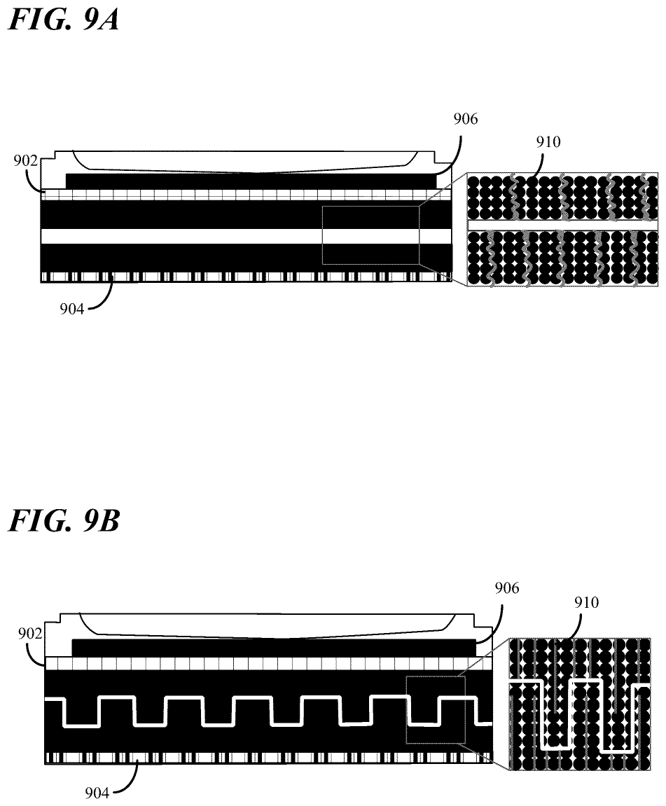

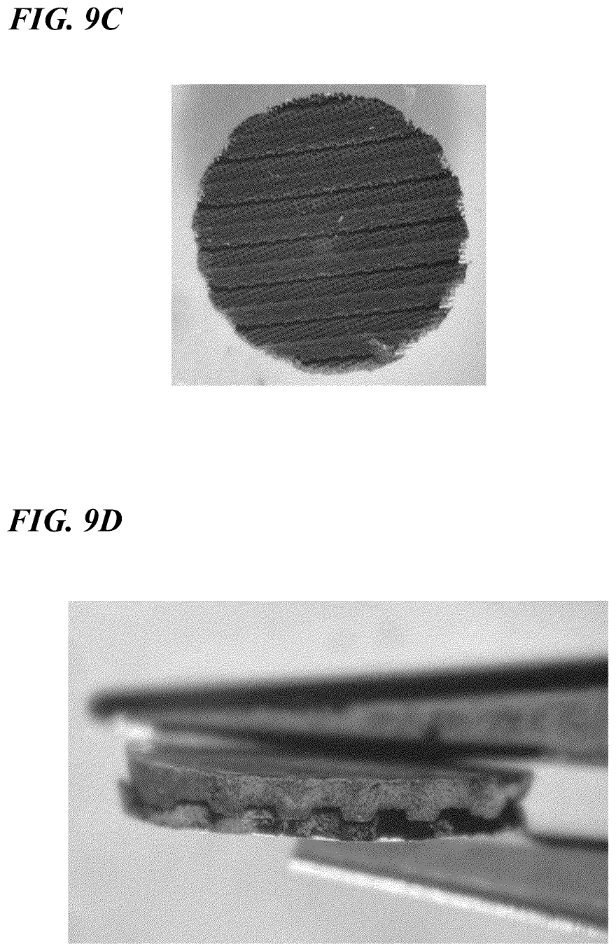

FIGS. 9A and 9B show a graphical comparison of the battery assembly and ion diffusion routes of a conventional thick electrode cell (FIG. 9A) and a thick electrode cell of one embodiment of the present disclosure (FIG. 9B). As shown in these figures, an interdigitated pattern was formed in the electrode active material of each of the anode 902 and cathode 904 of FIG. 9B. Ion diffusion routes 910 (i.e. holes) were also formed in each of the anode 902 and cathode 904 of FIG. 9B.

A conventional battery assembly (FIG. 9A) has long diffusion routes and present difficulty for the electrolyte to fully penetrate the cell. In contrast, the battery assembly of FIG. 9B had shortened ionic diffusion routes through the holes, which allows for rapid electrolyte penetration, and interdigitation patterns that increase the volumetric energy density of the battery assembly.

The electrodes of FIG. 9B were formed according to the following procedures. The cathode comprised an electrode active material of NMC622, carbon black, PVDF, and NMP. The anode comprised an electrode active material of MCMB, carbon black, PVDF, and NMP. Each electrode was slurry cast with the electrode active material and then dried in a vacuum. Each electrode had a final thickness after processing of 280 μm. To form the interdigitated pattern and ion diffusion routes, the following parameters were followed for the laser:
800 nm femtosecond Ti: Sapphire laser
Laser frequency: 1 kHz
Hole spacing: 0.125 mm
Groove width: 0.5 mm
Velocity: 18 mm/s
Dwell time for holes: 0.1 s

FIG. 9C shows a prepared electrode of one embodiment of the present disclosure comprising ion diffusion routes (i.e. holes) and an interdigitated pattern. FIG. 9D shows the interlocking of two electrodes having complimentary interdigitated patterns.

The battery assembly of FIG. 9B was then tested for specific charge capacity and specific discharge capacity over cycling. The battery was assembled to have the following parameters.

```
16 mm anode
14 mm cathode
Assembly of cell in argon glovebox
C-rate cycling:
      0.1 C (10 formation cycles)
      0.2 C (5 cycles)
      0.5 C (5 cycles)
      0.1 C (5 cycles)
Voltage range: 2.8-4.2 V
```

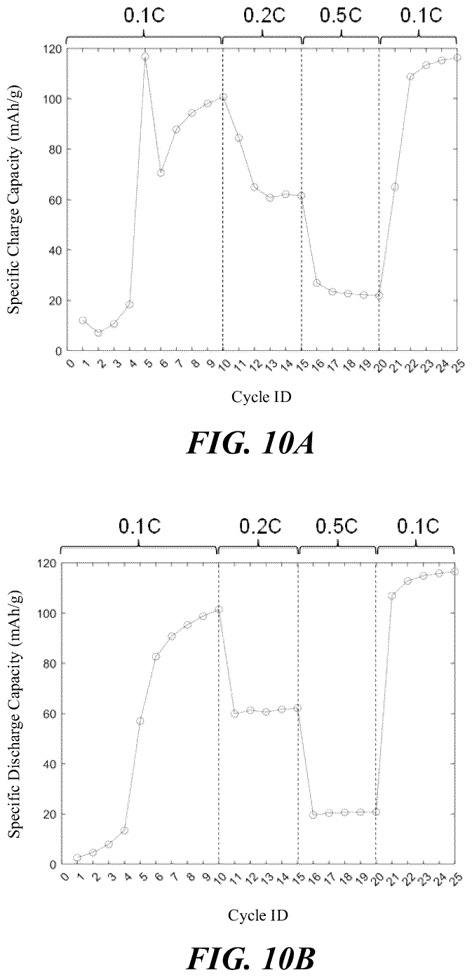

The results are set forth in FIGS. 10A and 10B.

### Example 2

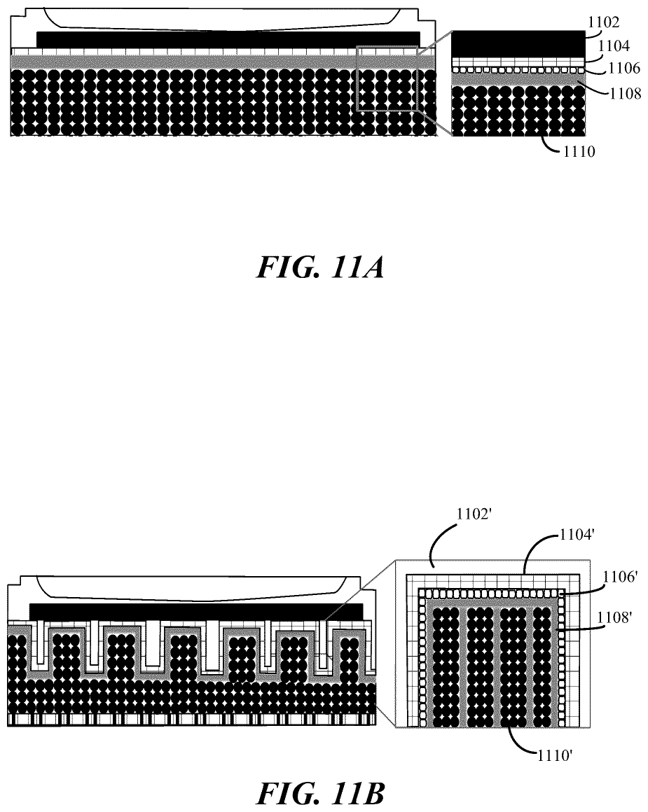

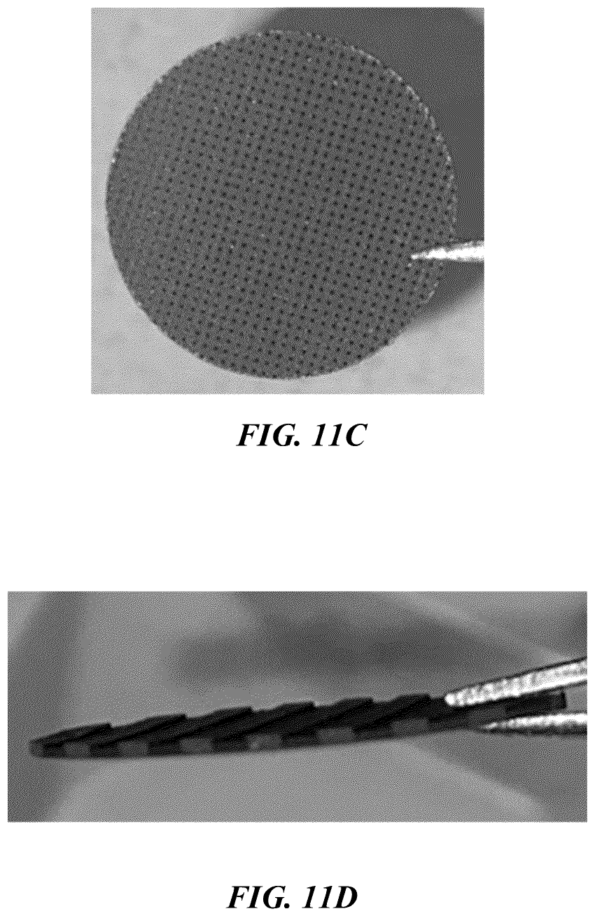

In a second example, anode-less battery cells with a solid state electrolyte were prepared. FIG. 11A shows a conventional anode-less battery assembly comprising an anode-less cell without structuring, and FIG. 11B shows an anode-less cell with structuring. The conventional anode-less battery assembly of FIG. 11A comprises an Al current collector 1102, a Cu current collector 1104, plated lithium 1106, a solid state electrolyte (SSE) 1108, and electrode active material 1110. The battery assembly of FIG. 11B comprises an Al current collector 1102′, a Cu current collector 1104′, plated lithium 1106′, a SSE 1108′, and electrode active material 1110′.

The planar solid-state electrolyte 1108 of the conventional anode-less battery assembly of FIG. 11A provides minimal interface with electrode active material 1110, but generally has low ionic conductivity with sluggish performance (due to the thickness). In contrast, the battery assembly of FIG. 11B has femtosecond laser micro-drilled holes which allows SSE 1108′ incorporation into the electrode active material 1110′. This results in an overall reduced ionic travel distance, and enables the use of current low ionic conductivity SSEs in this embodiments. The grooved surface provides increased surface area for lithium plating on Cu current collector.

The assembly of FIG. 11B was formed according to the following procedures. The cathode active material was comprised of NMC622, carbon black, PVDF, and NMP. The cathode was slurry cast with the electrode active material and then dried in a vacuum oven. The cathode had a final thickness after processing of 80 μm. in the final assembly, the cathode was 14 mm and the Cu current collector was 16 mm.

FIG. 11C shows a prepared electrode of one embodiment of the present disclosure comprising ion diffusion routes (i.e. holes) and groove patterns. FIG. 11D shows a profile view detailing the grooves present within the electrode.

### Example 3

In a third example, a battery assembly comprising a thin film (80 μm) electrode, utilizing a liquid electrolyte, was fabricated and tested in a planar anode-less cell configuration against Cu foil.

The electrode was formed according to the following procedures. The cathode comprised an electrode active material of NMC622, carbon black, PVDF, and NMP. The electrode was slurry cast with the electrode active material and then dried in a vacuum. The electrode had a final thickness after processing of 80 μm.

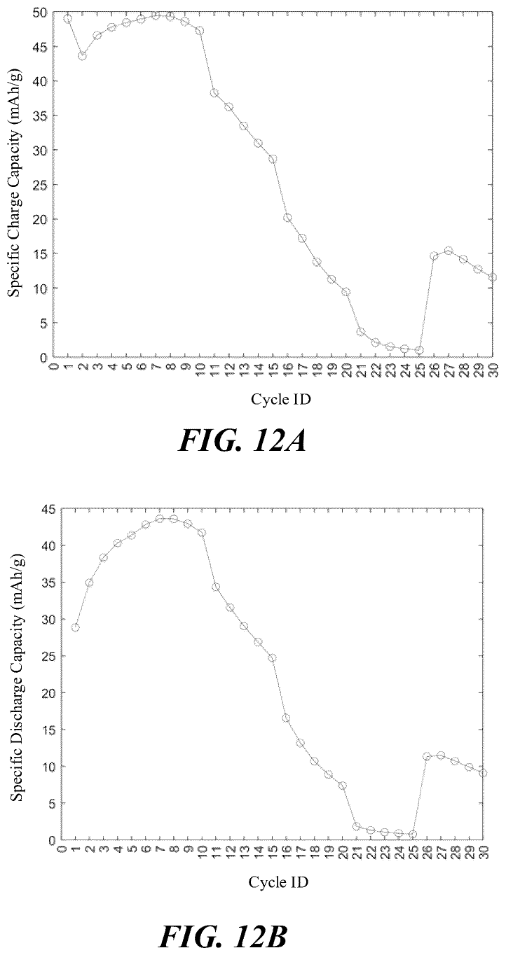

The battery assembly was then tested for specific charge capacity (FIG. 12A) and specific discharge capacity (FIG. 12B) over cycling. The battery was assembled to have the following parameters. The battery was not subjected to the laser processing described elsewhere herein.

```
14 mm cathode
16 mm Cu current collector
Liquid electrolyte used within cell
Assembly of cell in argon glovebox (Cathode →
separator → Cu current collector
C-rate cycling:
      0.1 C-10 cycles (formation)
      0.2 C-5 cycles
      0.5 C-5 cycles
      1 C-5 cycles
      0.2 C-5 cycles
Voltage range: 2.8-4.2 V
```

### Example 4

Next an interdigitated pillar electrode structure was prepared in accordance with one embodiment described herein. That is, the experiment utilized a pillared casing to create interdigitated electrode structures. A 3D printed casing of the interdigitated pattern was prepared. The entire electrode (including anode, separator, and cathode) were then pressed between the 3D casing, resulting in well-matched and interdigitated electrodes. Subsequently, an electric field is applied to arrange particle alignment.

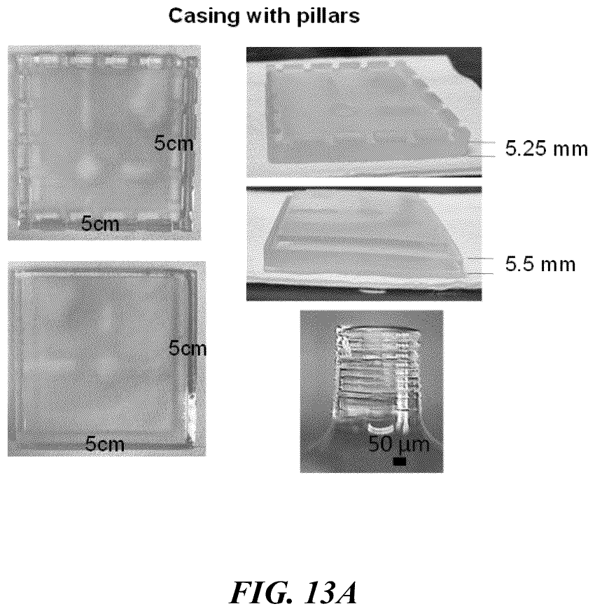

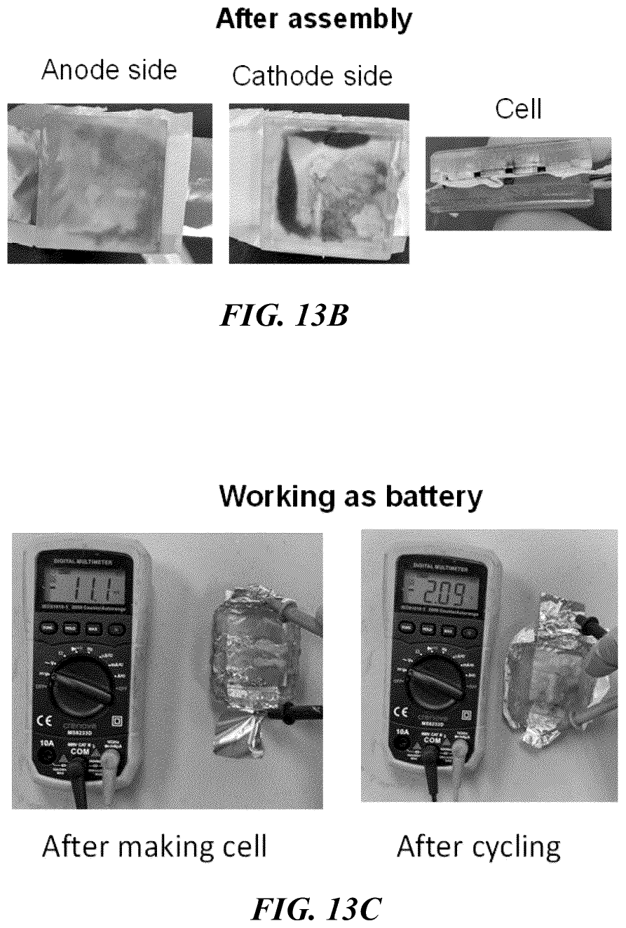

The 3D printed casing is shown in FIG. 13A, the assembly of the battery structure is shown in FIG. 13B, and the testing of the resulting battery structure is shown in FIG. 13C.

### Example 5

Several anodes and cathodes were prepared in the manner described herein comprising an interdigitated pattern formed by laser-structuring. The anodes and cathodes were subjected to imaging and analysis to determine the groove height (and consistency) of the various electrodes.

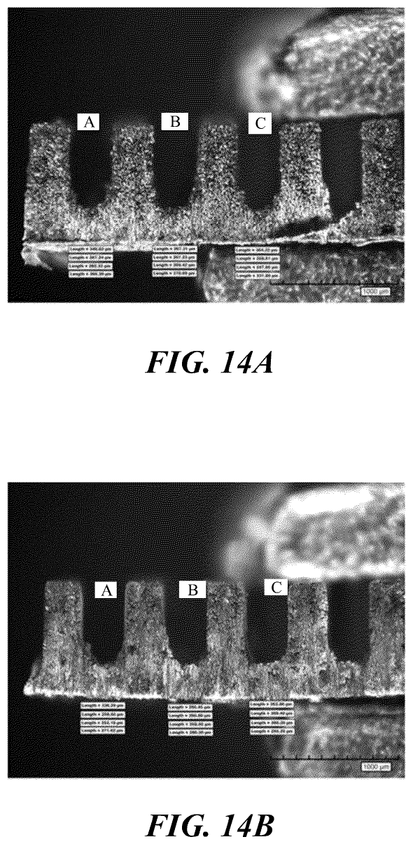

An exemplary image of a cross-section of a laser-structured anode illustrating groove height of the anode is shown in FIG. 14A. The anode shown in FIG. 14A includes the following groove heights.

Groove Height

| Groove A | Groove B | Groove C |
|---|---|---|
| 340.62 μm | 267.31 μm | 364.22 μm |
| 267.24 μm | 267.23 μm | 258.61 μm |
| 282.33 μm | 269.42 μm | 247.85 μm |
| 366.39 μm | 370.69 μm | 331.89 μm |

FIG. 14B shows an exemplary image of a cross-section of a laser-structured cathode illustrating groove height of the cathode. The cathode shown in FIG. 14B includes the following groove heights.

Groove Height

| Groove A | Groove B | Groove C |
|---|---|---|
| 336.20 μm | 295.45 μm | 262.96 μm |
| 258.65 μm | 260.8 μm | 269.40 μm |
| 252.18 μm | 258.65 μm | 280.20 μm |
| 271.62 μm | 280.20 μm | 295.26 μm |

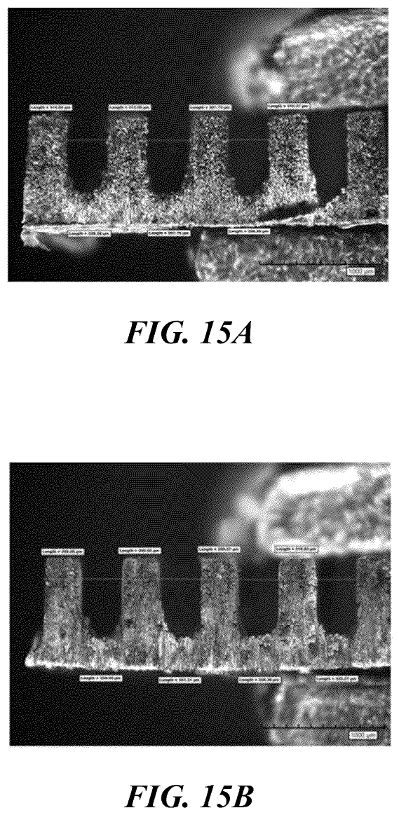

FIG. 15A shows an exemplary image of a cross-section of a laser-structured anode illustrating pillar width and groove width of the anode. The anode shown in FIG. 15A includes the following pillar and groove widths.

| Pillar Width | Groove Width |
|---|---|
| 314.65 μm | 338.38 μm |
| 312.50 μm | 357.75 μm |
| 301.72 μm | 338.36 μm |
| 310.37 μm | |

FIG. 15B shows an exemplary image of a cross-section of a laser-structured cathode illustrating pillar width and groove width of the cathode. The cathode shown in FIG. 15B includes the following pillar and groove widths.

| Pillar Width | Groove Width |
|---|---|
| 299.56 μm | 334.04 μm |
| 290.95 μm | 351.31 μm |
| 299.57 μm | 338.38 μm |
| 316.83 μm | 323.27 μm |

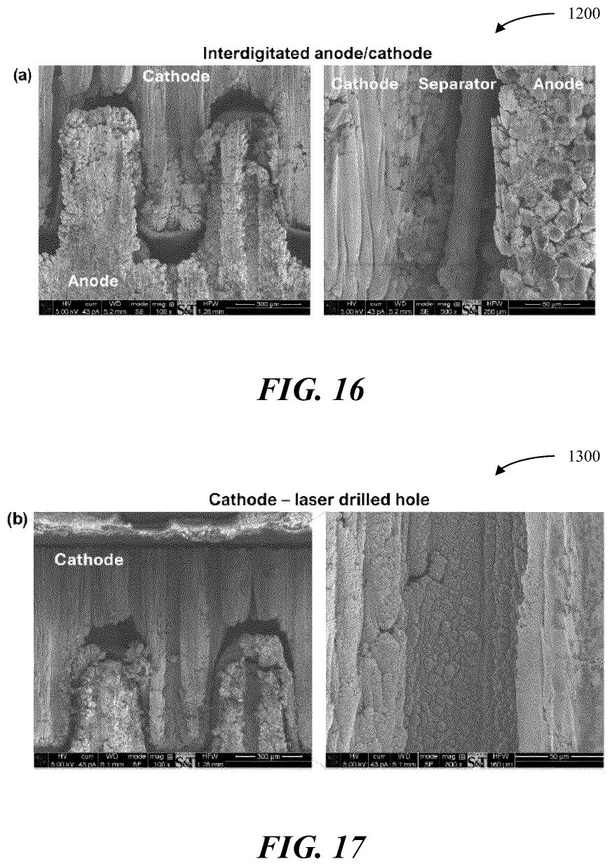

FIG. 16 is an exemplary image of an interdigitated anode and cathode. FIG. 17 is an exemplary image of an ion transport route comprising a laser-drilled hole through a pillar of a cathode, with the rightmost image showing a further expanded view of the hole.

### Example 6

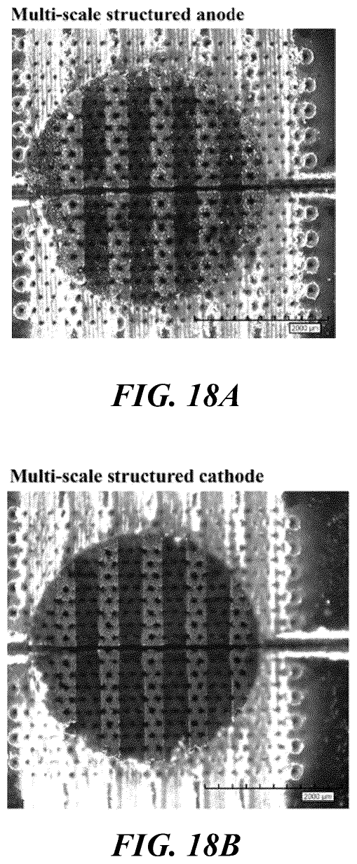

Next an anode and cathode having ion transport routes (holes) and grooves/interdigitated pattern were cross-sectioned for analysis. FIG. 18A and FIG. 18B show the top-down view of a cross section of a structured anode (FIG. 18A) and structured cathode (FIG. 18B).

### Example 7

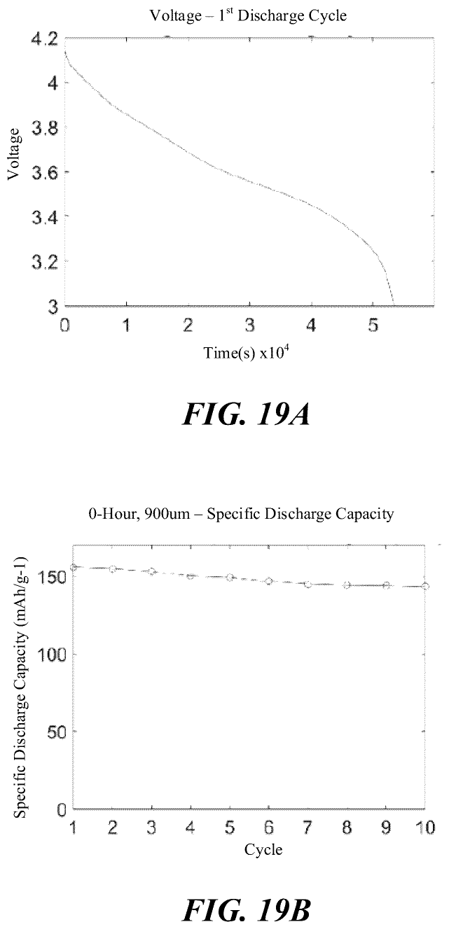

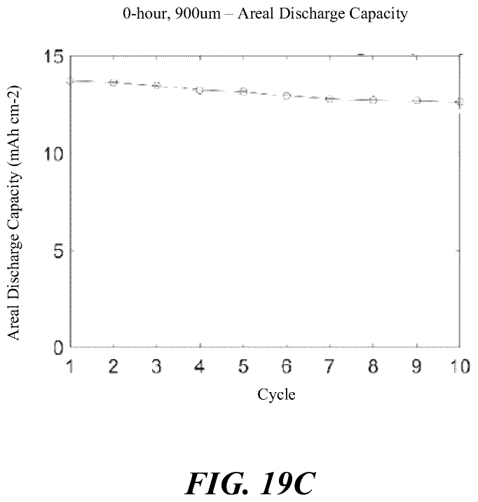

FIG. 19A-C show graphs indicating electrochemical performance of a laser-structured battery of the present disclosure wherein an electric field is applied during casting. Specifically, the battery contains electrodes that had an electric field applied during casting of the electrode slurry, but not during the drying of the wet electrode. Both electrodes used in this battery were laser-structured with the interdigitated groove and hole design.

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above products without departing from the scope of the invention, it is intended that all matter contained in the above description and shown in the accompanying drawings shall be interpreted as illustrative and not in a limiting sense.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

1. A method for preparing an electrode, the method comprising:
providing a current collector with a structured pattern on at least one surface thereof;
providing an electrode material slurry;
casting the electrode material slurry onto the at least one surface of the current collector having a structured pattern to form a wet intermediate electrode; and
drying the wet intermediate electrode to form the electrode.

2. The method of claim 1, wherein an electric field is applied during the casting and drying.

3. The method of claim 2, wherein the electric field is applied during the casting via a casting knife connected to a voltage source.

4. The method of claim 1, wherein the structured pattern on at least one surface of the current collector is prepared by laser structuring the current collector.

5. The method of claim 4, wherein the structured pattern is selected from the group consisting of a grid pattern, grooves, a hole array, horizontal lines, and combinations thereof.

6. The method of claim 1, further comprising processing the electrode such that the thickness of the electrode, as measured at any two points on a top surface of the electrode, differs by about 0.5 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less.

7. The method of claim 6, wherein processing the electrode comprises sanding the electrode to have a uniform thickness.

8. The method of claim 1, further comprising laser structuring the electrode.

9. The method of claim 8, wherein laser structuring the electrode comprises forming an interdigitated pattern into at least one surface of the electrode.

10. The method of claim 9, wherein the interdigitated pattern is selected from the group consisting of pillars, grooves, and combinations thereof.

11. The method of claim 8, wherein laser structuring the electrode comprises forming one or more ion transport routes through the electrode.

12. The method of claim 11, wherein the ion transport routes are selected from the group consisting of one or more holes, one or more grooves, and combinations thereof.

13. The method of claim 6, further comprising laser structuring the electrode.

14. The method of claim 13, wherein laser structuring the electrode comprises forming an interdigitated pattern into at least one surface of the electrode.

15. The method of claim 14, wherein the interdigitated pattern is selected from the group consisting of pillars, grooves, and combinations thereof.

16. The method of claim 13, wherein laser structuring the electrode comprises forming one or more ion transport routes through the electrode.

17. The method of claim 16, wherein the ion transport routes selected from the group consisting of one or more holes, one or more grooves, and combinations thereof.

18. The method of claim 1, further comprising forming a battery comprising the electrode.

19. A battery, wherein the battery comprises:
an anode and a cathode,
wherein the anode comprises an interdigitated pattern on at least one surface thereof, the anode comprises one or more ion transport routes through the anode, and the thickness of the anode, as measured at any two points on a top surface of the anode, differs by about 0.5 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less;
wherein the cathode comprises an interdigitated pattern on at least one surface thereof, the cathode comprises one or more ion transport routes through the cathode, and the thickness of the cathode, as measured at any two points on a top surface of the cathode, differs by about by about 0.5 mm or less, about 0.25 mm or less, about 0.10 mm or less, about 75 μm or less, about 50 μm or less, about 45 μm or less, about 40 μm or less, about 35 μm or less, about 30 μm or less, about 25 μm or less, about 20 μm or less, about 15 μm or less, about 10 μm or less, about 5 μm or less, about 4 μm or less, about 3 μm or less, about 2 μm or less, about 1 μm or less, or about 0.5 μm or less; and
wherein the interdigitated pattern on at least one surface of the anode is configured to align to the interdigitated pattern on at least one surface of the cathode.

20. The battery of claim 19, wherein the interdigitated pattern on at least one surface of the anode comprises pillars, grooves, or combinations thereof and/or the interdigitated pattern on at least one surface of the cathode comprises pillars, grooves, or combinations thereof.
